(19) United States
(12) Patent Application Publication
(10) Pub. No.: US 2019/0131733 A1
(43) Pub. Date: May 2, 2019

(54) CONNECTION TERMINAL AND CONNECTION TERMINAL PAIR

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Ryoma TAKAGI, Yokkaichi (JP); Hajime WATANABE, Yokkaichi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 16/094,758

(22) PCT Filed: Apr. 11, 2017
(86) PCT No.: PCT/JP2017/014801

§ 371 Date: Oct. 18, 2018

(30) Foreign Application Priority Data
Apr. 20, 2016 (JP) 2016-084100

(51) Int. Cl. H01R 13/03; C25D 5/12; C25D 5/50; C25D 7/00; H01R 12/58

(52) U.S. Cl. CPC H01R 13/03; C25D 5/12; H01R 12/585; C25D 7/00; C25D 5/50

(57) ABSTRACT

A connection terminal that includes an alloy containing layer, in which grains of an alloy part made of an alloy mainly containing tin and palladium are present in a tin part made of pure tin or an alloy having a higher tin ratio than the alloy part, wherein: both the alloy part and the tin part are exposed on an outermost surface of a contact point to be electrically brought into contact with another conductive member, and a number of the grains having an area circle equivalent diameter of 1.0 μm or larger is 30% or higher to a total number of the grains in a grain size distribution of the grains of the alloy part on the outermost surface of the contact point.

This application is the U.S. National Phase of PCT/JP2017/014801 filed Apr. 11, 2017, which claims priority from JP 2016-084100 filed Apr. 20, 2016, the entire disclosure of which is incorporated herein by reference.

### BACKGROUND

The present disclosure relates to a connection terminal and a connection terminal pair, more particularly to a connection terminal including a metal layer containing an alloy on a surface and a terminal pair including such a connection terminal.

Conventionally, a material obtained by applying tin plating to a surface of a base material such as copper or copper alloy has been generally used as a material constituting connection terminals In a tin plating layer, an insulating tin oxide coating is formed on a surface, but the tin oxide coating is destroyed with a weak force, metal tin is easily exposed and a good electrical contact is formed on the surface of the soft metal tin.

However, in a tin plated terminal, there is a problem that a friction coefficient of surface is large and a force necessary to insert a connection terminal (insertion force) tends to increase due to the softness and easy adhesion of tin. Accordingly, a connection terminal having an alloy containing layer, in which a domain structure of a first metal phase made of an alloy of tin and palladium is formed in a second metal phase made of pure tin or an alloy having a higher tin ratio to palladium or the first metal phase, on a surface has been proposed in International Publication No. 2013/168764. Since the hard tin-palladium alloy is exposed on an outermost surface of the connection terminal, a low friction coefficient is obtained. Simultaneously, connection reliability is also ensured since tin is exposed on the outermost surface.

### SUMMARY

If an alloy containing layer, in which a tin-palladium alloy as disclosed in International Publication No. 2013/168764 is exposed together with tin on an outermost surface, is formed on a surface of a connection terminal, a reduction of a friction coefficient can be achieved as compared to tin plated terminals. However, a further study of the present inventor and other researchers found out that a friction coefficient could be particularly effectively reduced by controlling a grain size distribution of tin-palladium alloy grains exposed on an outermost surface and that the abrasion of a surface metal layer of a mating terminal could be reduced when a connection terminal formed with an alloy containing layer and the mating terminal slid on each other.

An exemplary aspect of the present disclosure provides a connection terminal including an alloy containg layer, in which a tin-palladium alloy is exposed together with tin on an outermost surface, and capable of effectively reducing a friction coefficient and suppressing the abrasion of a surface metal layer of a mating terminal when the connection terminal and the mating terminal slide on each other, and a connection terminal pair including such a connection terminal.

To achieve the above object, a connection terminal according to the present disclosure is a connection terminal that includes an alloy containing layer, in which grains of an alloy part made of an alloy mainly containing tin and palladium are present in a tin part made of pure tin or an alloy having a higher tin ratio than the alloy part, wherein: both the alloy part and the tin part are exposed on an outermost surface of a contact point to be electrically brought into contact with another conductive member, and a number of the grains having an area circle equivalent diameter of 1.0 μm or larger is 30% or higher to a total number of the grains in a grain size distribution of the grains of the alloy part on the outermost surface of the contact point.

Here, the number of the grains having the area circle equivalent diameter of 1.0 μm or larger may be 60% or higher to the total number of the grains in the grain size distribution of the grains of the alloy part on the outermost surface of the contact point.

Further, an underlayer made of nickel or nickel alloy may be provided between a base material forming the connection terminal and the alloy containing layer.

An exposed area ratio of the alloy part occupying a surface of the alloy containing layer may be 10% or higher and 95% or lower.

The number of the grains of the alloy part exposed on the outermost surface per area of 500 μm² of the outermost surface of the contact point may be 10 or more and 400 or less.

A connection terminal pair according to the present disclosure includes the connection terminal as described above, and a mating terminal to be electrically brought into contact with the connection terminal on the contact point.

Here, the mating terminal may be such that a metal layer having a lower hardness than the alloy part is exposed on a surface of the contact point to be electrically brought into contact with the connection terminal.

In the connection terminal according to the present disclosure, since the alloy part made of the hard tin-palladium alloy is exposed on the outermost surface of the contact point, a low friction coefficient is obtained on the contact point. In the grain size distribution of the grains of the alloy part, the number of the grains having the area circle equivalent diameter of 1.0 μm or larger is specified to be 30% or higher to the total number of the grains to guarantee the ratio of the alloy grains each having a surface having a relatively large area exposed on the outermost surface, whereby a particularly low friction coefficient can be obtained. Further, when such a connection terminal is used by being slid on a mating terminal., the abrasion of a surface metal layer of the mating terminal due to friction with the alloy part can be suppressed.

Here, if the number of the grains having the area circle equivalent diameter of 1.0 μm or larger is 60% or higher to the total number of the grains in the grain size distribution of the grains of the alloy part on the outermost surface of the contact point, a reduction of the friction coefficient and the suppression of the abrasion of the surface metal layer of the mating terminal can be particularly effectively achieved.

Further, if the underlayer made of nickel or nickel alloy is provided between the base material forming the connection terminal and the alloy containing layer, the adhesion of the alloy containing layer to the base material can be enhanced and heat resistance of the alloy containing layer can be enhanced.

If the exposed area ratio of the alloy part occupying a surface of the alloy containing layer is 10% or higher and 95% or lower, an effect of reducing the friction coefficient and suppressing the abrasion of the surface metal layer of the mating terminal exhibited by the alloy part having the grain size distribution controlled on the connection terminal surface is easily combined with high connection reliability exhibited by the tin part.

If the number of the grains of the alloy part exposed on the outermost surface per area of 500 μm² of the outermost surface of the contact point is 10 or more and 400 or less, a reduction of the friction coefficient and the suppression of the abrasion of the surface metal layer of the mating terminal can be achieved with high accuracy.

In the connection terminal pair according to the present disclosure, one connection terminal forming the terminal pair is the connection terminal including the alloy containing layer on the surface of the contact point as described above. Thus, a low friction coefficient is obtained on the contact point where the two connection terminals are in contact, and the abrasion of the surface metal layer of the mating terminal can be suppressed.

If the mating terminal is such that the metal layer having a lower hardness than the alloy part is exposed on the surface of the contact point to be electrically brought into contact with the connection terminal, the connection reliability of the contact point is easily ensured by a low hardness of the surface metal layer of the mating terminal. Generally, a surface metal layer having a low hardness is subject to abrasion. However, since the connection terminal includes the alloy containing layer as described above on the surface of the contact point, it can be effectively suppressed that the surface metal layer having a low hardness of the mating terminal is subject to abrasion.

### BRIEF DESCRIPTION OF THE DRAWINGS

FIG. 1 is a section showing a material constituting a connection terminal according to one embodiment of the present disclosure,

FIG. 2 is a view showing a press-fit terminal as an example of the connection terminal,

FIG. 3 are SEM images each obtained by observing a surface having a tin part removed, wherein FIGS. 3(a) to 3(d) respectively show Examples 1 to 4,

FIG. 4 are histograms each showing a grain size distribution using an area circle equivalent diameter of alloy parts as an index, wherein FIGS. 4(a) to 34d) respectively show Examples 1 to 4,

FIG. 5 are views (upper stage) each showing a friction coefficient at the time of sliding on a mating tin plated contact point and pictures (lower stage) each showing an abraded state of the mating tin plated contact point, wherein FIG. 5(a) corresponds to Comparative Example 1 and FIGS. 5(b) to 5(e) respectively correspond to Examples 1 to 4,

FIG. 6 is a graph showing a relationship between a ratio of alloy grains having an area circle equivalent diameter of 1.0 μm or larger and the friction coefficient, and

FIG. 7 is a graph showing a relationship between a grain size average and the friction coefficient.

### DETAILED DESCRIPTION OF EMBODIMENTS

Hereinafter, a connection terminal according to one embodiment of the present disclosure is described in detail using the drawings, In the connection terminal according to the embodiment of the present disclosure, a contact point portion to be electrically brought into contact with a mating conductive member such as a mating terminal is made of a terminal material including an alloy containing layer to be described below on a surface.

[Summary of Terminal Material Including Alloy Containing Layer]

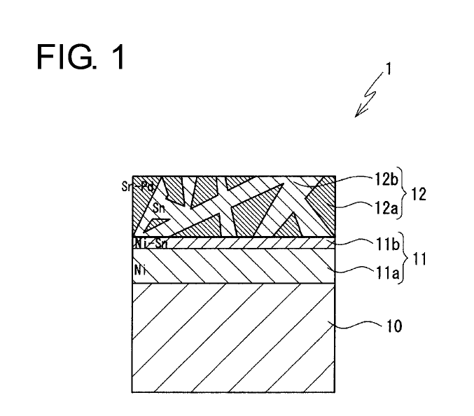

A terminal material 1 constituting the connection terminal has a layer configuration as schematically shown in a section of FIG. 1. That is, an alloy containing layer 12 is appropriately formed on a surface of a base material 10 with an underlayer 11 therebetween.

The base material 10 is, for example, an alloy mainly containing copper, aluminum, iron or these. Out of these, copper or copper alloy having a high conductivity and generally used as a base material of connection terminals is particularly preferable.

The alloy containing layer 12 is composed of alloy parts 12a made of an alloy mainly containing tin and palladium and a tip part 12b made of pure tin or an alloy having a higher tin ratio than the alloy portions 12a. The alloy parts 12a are segregated in the tin part 12b to form three-dimensional domain-like (island-like, cluster-like) grains. The alloy parts 12a and the tin part 12b are both exposed on an outermost surface of the alloy containing layer 12. In the outermost surface of the alloy containing layer 12, the hard alloy parts 12a function o reduce a friction coefficient and the soft tin part 12b having a high conductivity functions to enhance connection reliability.

The alloy part 12a is mainly made of a tin-palladium alloy. However, a small amount. of a metal element constituting the underlayer 11 such as nickel, a metal element constituting the base material 10, unavoidable impurities, a phase of palladium not taken into the alloy and the like may be contained in the alloy.

In terms of sufficiently exhibiting an effect of reducing the friction coefficient, the content of palladium is preferably 1 atom % or higher, particularly preferably 2 atom % or higher, further preferably 4 atom % or higher in the entire alloy containing layer 12, i.e. in the entire area of the alloy containing layer 12 combining the alloy parts 12a and the tin part 12b. On the other hand, the tin-palladium alloy is known to form a stable intermetallic compound made of PdSn₄, and the content of palladium is preferably below 20 atom % in terms of constituting the alloy parts 12a occupying parts of the alloy containing layer 12 mainly by this intermetallic compound. Further, in terms of sufficiently ensuring the tin part 12b and effectively achieving connection reliability by the tin part 12b, an upper limit value of the content of palladium is more preferably 7 atom %.

Further, in terms of sufficiently exhibiting a property of the alloy containing layer 12 to enhance connection reliability while reducing the friction coefficient of the surthce, a thickness of the entire alloy containing layer 12 is preferably 0.8 μm or larger.

The underlayer 11 is made of nickel or nickel alloy and functions to enhance the adhesion of the alloy containing layer 12 to the base material 10 and suppress the diffusion of metal atoms from the base material 10 to the alloy containing layer 12. Out of the nickel underlayer 11, a part on the side of the alloy containing layer 12 may be formed into a nickel-tin alloy layer 11b by heating in a process of forming the alloy containing layer 12. A remaining part of the nickel underlayer 11 serves as a nickel layer 11a not to be alloyed with tin. By forming the nickel-tin alloy layer 11b, the diffusion of metal atoms from the base material 10 to the alloy containing layer 12 is strongly impeded even at high temperatures, whereby it is suppressed that contact resistance increases on the outermost surface due to the diffusion of the metal atoms from the base material 10 to the outermost surface at high temperatures. As a result, heat resistance of the base material 10 is particularly improved.

The alloy containing layer 12 can be formed, for example, by laminating a tin plating layer and a palladium plating layer in this order on the surface of the base material 10 or the surface of the underlayer 11 and alloying these layers by heating. Alternatively, the alloy containing layer 12 may be formed by eutectoid using a plating solution containing both tin and palladium. In terms of easiness, the former method of alloying the laminated tin plating layer and palladium plating layer is preferable. By adjusting a heating temperature and/or a heating time in alloying, a state of grains of the alloy parts 12a to be described next can be controlled in the obtained alloy containing layer 12.

[State of Grains of Alloy Parts in Outermost Surface]

(1) Grain Size Distribution

In the connection terminal according to this embodiment, a grain size distribution of the grains of the alloy parts 12a is as follows in the outermost surface of a contact point portion.

That is, in a distribution of area circle equivalent diameters of the grains of the alloy parts 12a in the outermost surface, the number of the grains having an area circle equivalent diameter of 1.0 μm or larger is 30% or higher to a total number of the grains. Here, the area circle equivalent diameter is calculated as follows. A surface area of each grain is read in a two-dimensional plane exposed on the outermost surface of the alloy containing layer 12 and a diameter of a circle having the same area as the read surface area is calculated as the area circle equivalent diameter.

The area circle equivalent diameters of the grains can be estimated by performing an image analysis after appropriately applying a process such as grain identification by binarization to a microscope image obtained by observing the surface of the alloy containing layer 12 by a scanning electron microscope (SEM) or the like. To enable an analysis by clearly separating the grains of the alloy parts 12a from the tin part 12b, the tin part 12b may be selectively removed before the microscope image is obtained. As a method for selectively removing the tin part 12b, etching may be performed, for example, by bringing a mixed aqueous solution of sodium hydroxide and p-nitrophenol into contact with the alloy containing layer 12. Note that it has been confirmed that grain shapes of the alloy parts do not change even if etching is performed.

In estimating a ratio of the grains having the area circle equivalent diameter of 1.0 μm or larger, the area circle equivalent diameter of each grain may be analyzed for an area for which a statistical process can be sufficiently performed in a microscope image. For example, the analysis may be performed for a region having an area of 500 μm².

If the ratio of the grains having the area circle equivalent diameter of 1.0 μm or larger is 30% or higher in the grain size distribution of the alloy parts 12a in the outermost surface of the alloy containing layer 12, the friction coefficient on the surface of the alloy containing layer 12 can be effectively reduced. Further, when the connection terminal including the alloy containing layer 12 is slid on a mating terminal, the abrasion of a surface metal layer (mating metal layer) of the mating terminal can be effectively suppressed.

In order for the alloy parts 12a exposed on the surface of the alloy containing layer 12 to effectively contribute to a reduction of the friction coefficient, the hard tin-palladium alloy needs to be exposed as a continuous surface spreading over a certain area on the outermost surface and slide on the mating terminal on that continuous surface. Thus, if the ratio of the grains of the alloy parts 12a having the large area circle equivalent diameters and exposed over a large area on the outermost surface is high, the friction coefficient of the surface can be effectively reduced.

Further, the grains of the alloy parts 12a having the large area circle equivalent diameters on the outermost surface sufficiently grow also in a depth direction of the alloy parts 12a and occupy a large volume in many cases. If the grains three-dimensionally occupying a large volume in that way are formed into a column in a depth. direction of the alloy containing layer 12, those grains are not easily peeled off from the alloy containing layer 12 even if being rubbed on the surfaces. Since the grains of the alloy parts 12a are less likely to be peeled off, the abrasion of the mating metal layer induced by the peeling-off is suppressed. This effect of suppressing the abrasion is particularly notably exhibited when the mating metal layer is a metal layer having. a lower hardness than the alloy parts 12a and subject to abrasion such as a tin layer.

If a ratio of the grains having a small area circle equivalent diameter is high in the grain size distribution of the grains of the alloy parts 12a on the outermost surface of the alloy containing layer 12, the friction coefficient on the surface of the alloy containing layer 12 cannot be effectively reduced. Further, the abrasion of the mating metal layer is likely to occur. This is for the following reason. If the hard tin-palladium alloy is composed of fine grains having a small area circle equivalent diameter on the outermost surface, such fine grains of the alloy parts 12a are in point contact with the surface of the mating terminal, thereby biting into the surface of the mating terminal to easily increase the friction coefficient on the surface of the alloy containing layer 12. Further, fine grains are easily peeled off from the alloy containing layer 12 by friction and the peeled-off hard grains of the alloy parts act like a kind of abrasive to induce the abrasion of the mating metal layer at the time of sliding. These phenomena are particularly likely when the mating metal layer is a layer having a low hardness such as a tin layer.

If the ratio of the grains of the alloy parts 12a having the area circle equivalent diameter of 1.0 μm or larger is 30% or higher, a reduction of the friction coefficient and the suppression of the abrasion of the mating metal layer by the effect brought about by the grain size can be effectively achieved. Preferably, if the ratio of the grains having the area circle equivalent diameter of 1.0 μm or larger is 35% or higher, further 60% or higher, these effects can be further enhanced. Particularly as shown in Examples later, the friction coefficient is notably reduced in a region where the ratio is 60% or higher. There is no particular upper limit to the ratio of the grains having the area circle equivalent diameter of 1.0 μm or larger.

By specifying the grain size distribution of the alloy parts 12a in this way, a dynamic friction coefficient when the contact point portion of the connection terminal including the alloy containing layer 12 on the surface and the surface of the tin layer of the mating terminal slide on each other is preferably 0.6 or smaller. The dynamic friction coefficient of 0.5 or lower is more preferable.

As described above, the ratio of the grains having the area circle equivalent diameter of 1.0 μm or larger can be controlled by adjusting the heating temperature when the alloy containing layer 12 is formed by heating the laminated structure of the palladium layer and the tin layer. For example, if heating is performed at 240° C. or higher, the alloy containing layer 12 having the above ratio of 30% or higher is easily formed. Further, if heating is performed at 280° C. or higher, the alloy containing layer 12 having the above ratio of 60% or higher is easily formed.

As described above, to effectively achieve a reduction of the friction coefficient and the suppression of the abrasion of the mating metal layer, the grains of the alloy parts 12a having a certain large area need to contact the mating metal layer on the outermost surface of the alloy containing layer 12. As just described, since the area of the grains of the alloy parts 12a exposed on the outermost surface largely affects the friction coefficient and the abrasion of the mating metal layer, a reduction of the friction coefficient on the surface of the alloy containing layer 12 and the suppression of the abrasion of the mating metal layer can be highly achieved by specifying the grain size distribution using the area circle equivalent diameter as an index, out of various parameters reflecting the shapes and sizes of the alloy parts 12a in the connection terminal according to this embodiment,

Further, in using the area circle equivalent diameter as the index of the grain size distribution of the alloy parts 12a, a lower limit of the area circle equivalent diameter is set at 1.0 μm and the ratio of the number of the grains having the area circle equivalent diameter equal to or larger than the lower limit as an index as described above, whereby the alloy containing layer 12 capable of achieving a reduction of the friction coefficient and the suppression of the abrasion of the mating metal layer can be particularly precisely discriminated as compared to the case where an average value or a median of the area. circle equivalent diameters is used as an index. This is because grains effective in reducing the friction coefficient and suppressing the abrasion of the mating metal layer are the grains of the alloy parts 12a roughly having the area circle equivalent diameter of 1.0 μm and exposed on the outermost surface, and grains having the area circle equivalent diameter below 1.0 μm do not largely affect the friction coefficient and a degree of abrasion on the mating metal layer regardless of how these grains are distributed. The average value and the median also reflect a state of distribution of such small grains.

Actually, as shown in. Examples later, when a state of the alloy containing layer 12 changes and the grain size distribution of the alloy parts 12a changes, the ratio of the grains having the area circle equivalent diameter of 1.0 μm or larger may largely change even if the average value (grain size average) and the median of the area circle equivalent diameters change only moderately.

(2) States Other Than Grain Size Distribution

The alloy parts 12a in the alloy containing layer 12 are preferably in the following states in addition to having the grain size distribution using the area circle equivalent diameter as an index as described above.

An exposed area ratio of the alloy parts 12a occupying the surface of the alloy containing layer 12 is preferably 10% or higher, further preferably 30% or higher and particularly preferably 50% or higher in terms of effectively achieving a reduction of the friction coefficient and. the suppression of the abrasion of the mating metal layer. On the other hand, the exposed area ratio of the alloy parts 12a is preferably 95% or lower, further preferably 80% or lower in terms of sufficiently ensuring the tin part 12b on the outermost surface and obtaining high connection reliability. Note that the exposed area ratio of the alloy parts 12a is calculated as (area of the alloy parts 12a exposed on the surface)/(area of the entire surface of the alloy containing layer 12)×100 (%).

Further, per area of 500 μm² on the outermost surface of the alloy containing layer 12, the number of the grams of the alloy parts 12a exposed on the outermost surface is preferably 10 or more, further preferably 100 or more, or 150 or more in terms of effectively achieving a reduction of the friction coefficient and the suppression of the abrasion of the mating metal layer by the exposure of the alloy parts 12a. On the other hand, the number of the grains of the alloy parts 12a per area of 500 μm² is preferably 400 or less, further preferably 300 or less, particularly preferably 200 or less in terms of sufficiently ensuring the tin part 12b and obtaining high connection reliability and in terms of ensuring a relatively high ratio of the alloy grains having a large area circle equivalent diameter by suppressing the number of the grains of the alloy parts 12a as a whole. The grain number of the alloy parts 12a may also be evaluated on the basis of an observed microscope image obtained by selectively removing the tin part 12b similarly to the evaluation of the grain size distribution. Note that, in the case of evaluating the grain number with respect to a plurality of regions having the same area in a single sample, an average value of the grain numbers of the respective regions may be evaluated. Further, if an area of the contact point portion is smaller than 500 μm², the grain number may be converted into the one per 500 μm² and evaluated.

[Structure of Connection Terminal]

If at least the contact point portion to be electrically brought into contact with another conducive member is made of the terminal material 1 including the alloy containing layer 12 as described above, the connection terminal according to the embodiment of the present disclosure may have any structure.

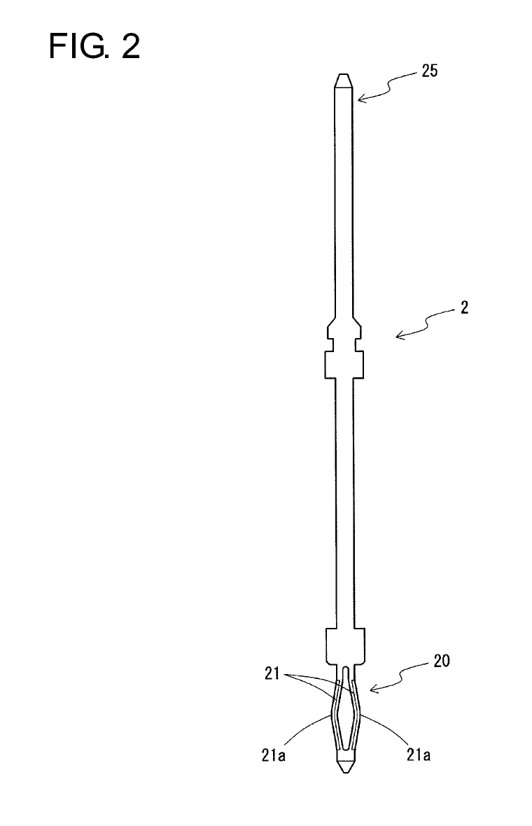

For example, the connection terminal can be formed as a press-fit terminal 2 as shown in FIG. 2. The press-fit terminal 2 is an electrical connection terminal shaped to be long and narrow as a whole, and includes a board connecting portion 20 to be press-fit and connected to a through hole of a printed board on one end and a terminal connecting portion 25 to be connected to a mating connection terminal such as by fitting on the other end. The press-fit terminal 2 is used in a PCB connector holding a multitude of press-fit terminals arranged side by side in many cases.

The board connecting portion 20 includes a pair of bulging pieces 21, 21 in a part to be press-fit and connected to the through hole. The bulging pieces 21, 21 are shaped to substantially arcuately bulge to be separated from each other in a direction perpendicular to an axial direction (vertical direction of FIG. 2) of the press-fit terminal 2. Top parts projecting most outward on outer side surfaces of the bulging pieces 21, 21 in bulging directions serve as contact point portions 21a, 21a to be brought into contact with an inner peripheral surface of the through hole. The terminal connecting portion 25 is in the form of a male fitting terminal. In such a press-fit terminal 2, the alloy containing layers 12 as described above are formed on the surfaces of the board connecting portion 20 and the terminal connecting portion 25, whereby a reduction of a friction coefficient and the suppression of the abrasion of a mating metal layer (inter peripheral surface of the through hole and a metal layer on the surface of the mating connection terminal) can be achieved between the board connecting portion 20 and the through hole and between the terminal connecting portion 25 and the mating connection terminal.

The connection terminal according to the embodiment of the present disclosure can be formed into various types and shapes such as fitting terminals. The alloy containing layer 12 may be formed on the entire connection terminal or only on a part of the connection terminal if being formed at least on the surface of the contact point portion. The friction coefficient on the surface of the contact point portion is reduced by the alloy parts 12a exposed on the outermost surface of the contact point portion, whereby an insertion force required to insert the connection terminal into the mating terminal is reduced.

The connection terminal according to the embodiment of the present disclosure is used in the form of a terminal pair by being combined with the mating terminal. In an example of the board connecting portion 20 of the above press-fit terminal 2, the inner periph.eral surface of the through hole is the mating terminal.

The type of a surface metal layer exposed on the surface of a contact point portion of the mating terminal is not particularly limited. However, taking it into account to ensure the connection reliability of the contact point portion, the surface metal layer of the mating terminal is preferably a layer having a lower hardness than the alloy parts 12a of the alloy containing layer 12 such as a tin layer. However, the surface metal layer having a low hardness such as a tin layer easily provides a high friction coefficient on the surface and is subject to abrasion by friction. Accordingly, by forming the alloy containing layer 12 with the exposed alloy parts 12a and tin part 12b on the surface of the connection terminal according to the embodiment of the present disclosure as a friction partner and controlling the grain size distribution of the alloy parts 12a to the predetermined state, an effect of reducing the friction coefficient and irn.proving connection reliability and an effect of suppressing abrasion on the surface metal layer having a low hardness on the mating terminal side are notably obtained. For example, an inner peripheral surface with a tin layer of a through hole of a printed board may be used as a mating terminal of the board connecting portion 20 of the above press-tit terminal 2.

### EXAMPLES

Examples and Comparative Example of the present disclosure are described below. Note that the present disclosure is not limited by these Examples.

[Fabrication of Samples]

(Examples 1 to 4)

A nickel under plating layer having a thickness of 1.0 μm was formed on a clean surface of a copper board and a palladium plating layer having a thickness of 0.02 μm was formed on the nickel under plating layer. Subsequently, a tin plating layer having a thickness of 1.0 μm was formed on the palladium plating layer. This was heated in the atmosphere, thereby forming a tin-palladium alloy containing layer, and plated members according to Examples 1 to 4 were formed. In Examples 1 to 4, a grain size distribution of a tin-palladium alloy was changed by changing a heating temperature as in Table 1 below.

(Comparative Example 1)

A tin plating layer having a thickness of 1.0 μm was formed on a surface of a copper board formed with a nickel under plating layer similar to the above. Then, a reflow process was performed by heating this at 250° C. in the atmosphere.

[Analysis of State of Alloy Parts]

The tin parts were removed from the samples of Examples 1 to 4. This was done by immersing each sample in a mixed aqueous solution of sodium hydroxide and p-nitrophenol. Surfaces of the obtained samples were observed by a SEM.

After grain identification by binarization was performed for the obtained SEM images, states of grains of alloy parts were analyzed by an image analysis. Specifically, an area circle equivalent diameter of each identified grain was measured. Further, the number of the grains in a visual field having an area of 500 μm² was counted. Furthermore, an exposed area ratio of the alloy parts was evaluated as a ratio of a total area of the grains of the alloy parts to the entire area of the image.

[Evaluation of Friction Coefficient]

Plate materials of Examples 1 to 4 and Comparative Example 1 were formed into flat contact points. Further, a plate material similar to that of Comparative Example including the tin layer on the surface was press-worked to form a semi-spherical embossed contact point having a radius of 1 mm. The embossed contact point was held in contact with the flat contact point in a vertical direction, the embossed contact point was slid in a horizontal direction at a speed of 10 mm/min while a load of 3 N was applied in the vertical direction, and a dynamic friction force was measured using a load cell. A value obtained by dividing the dynamic friction force by the load was set as a dynamic friction coefficient. A sliding movement was made over a distance of 5 mm.

[Test Results]

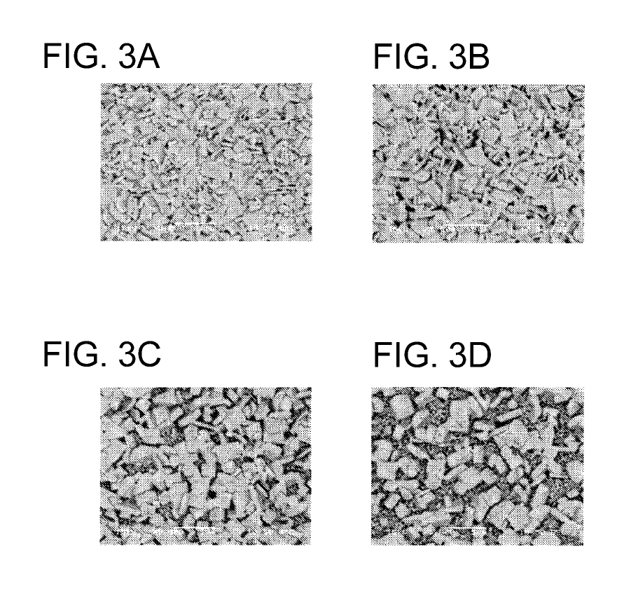

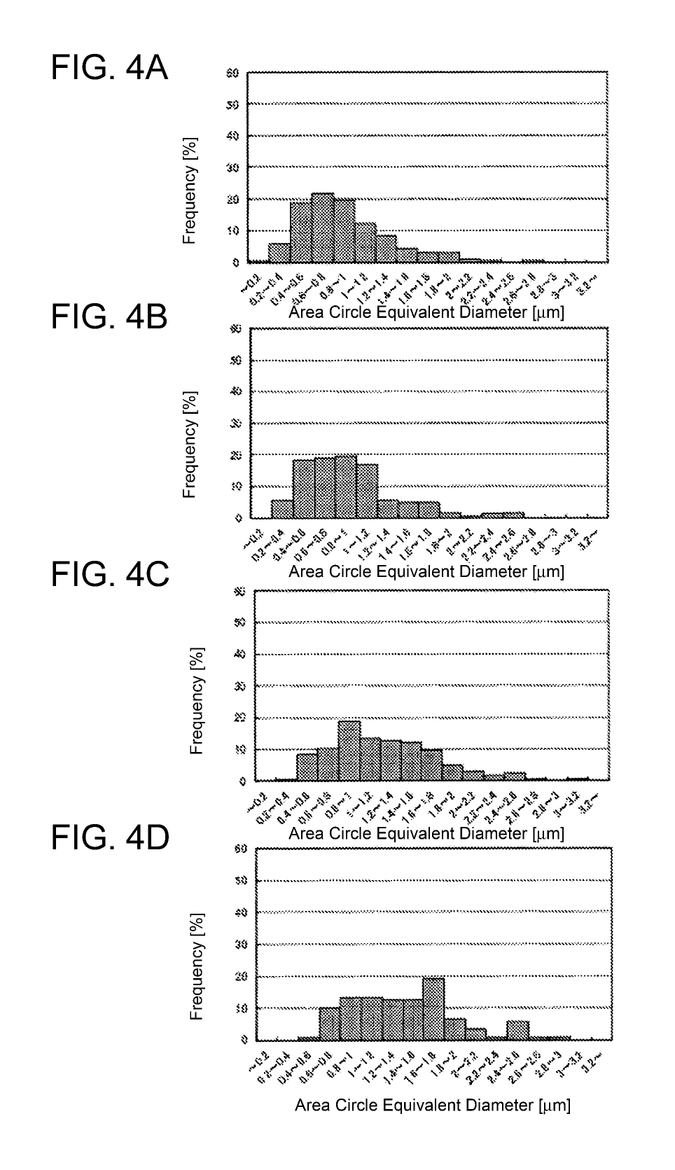

FIGS. 3(a) to 3(d) show SEM images of the samples according to Examples 1 to 4 in a state where the tin part on the surface was removed. Parts observed to be bright are the tin-palladium alloy, and parts observed to he dark are the exposed nickel-tin alloy layer produced by the alloying of the nickel underlayer and the tin plating layer and exposed by removing the tin part. Further, FIGS. 4(a) to 4(d) show the grain size distribution of the tin-palladium alloy using the area circle equivalent diameter estimated based on the SEM image of FIG. 3 as an index for each of Examples 1 to 4.

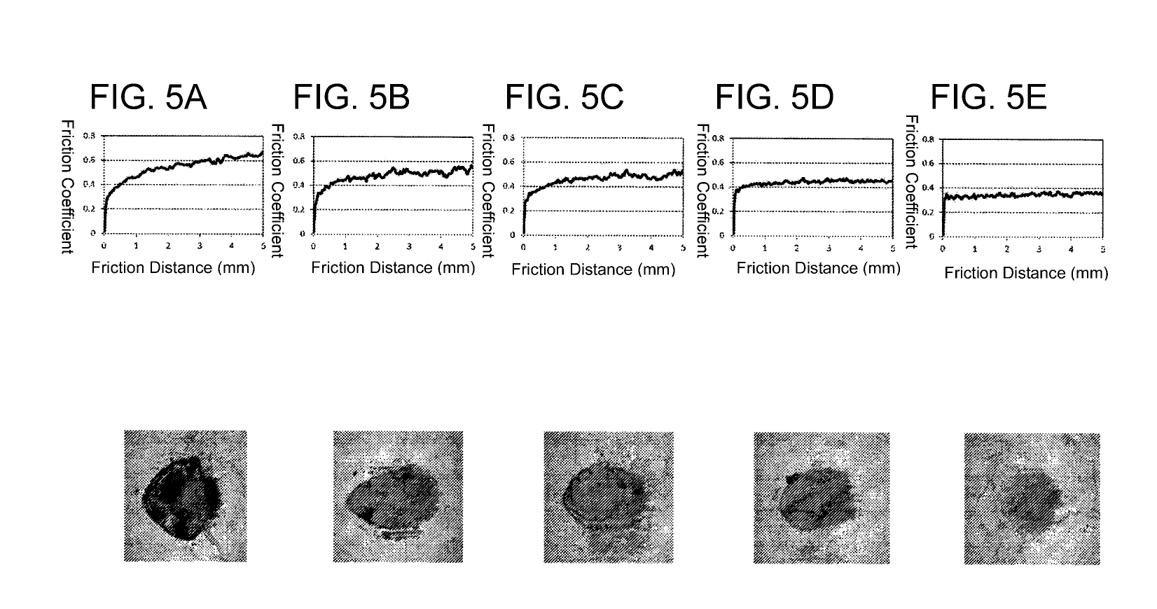

In upper stages of FIGS. 5(a) to 5(e), the dynamic friction coefficients measured for Comparative Example 1 and Examples 1 to 4 are shown as functions of a friction distance. Optical microscope images observed after a sliding movement on the surface of the embossed contact point including the tin layer on the surface are shown in lower stages. Parts observed to dark are parts where the tin layer is abraded.

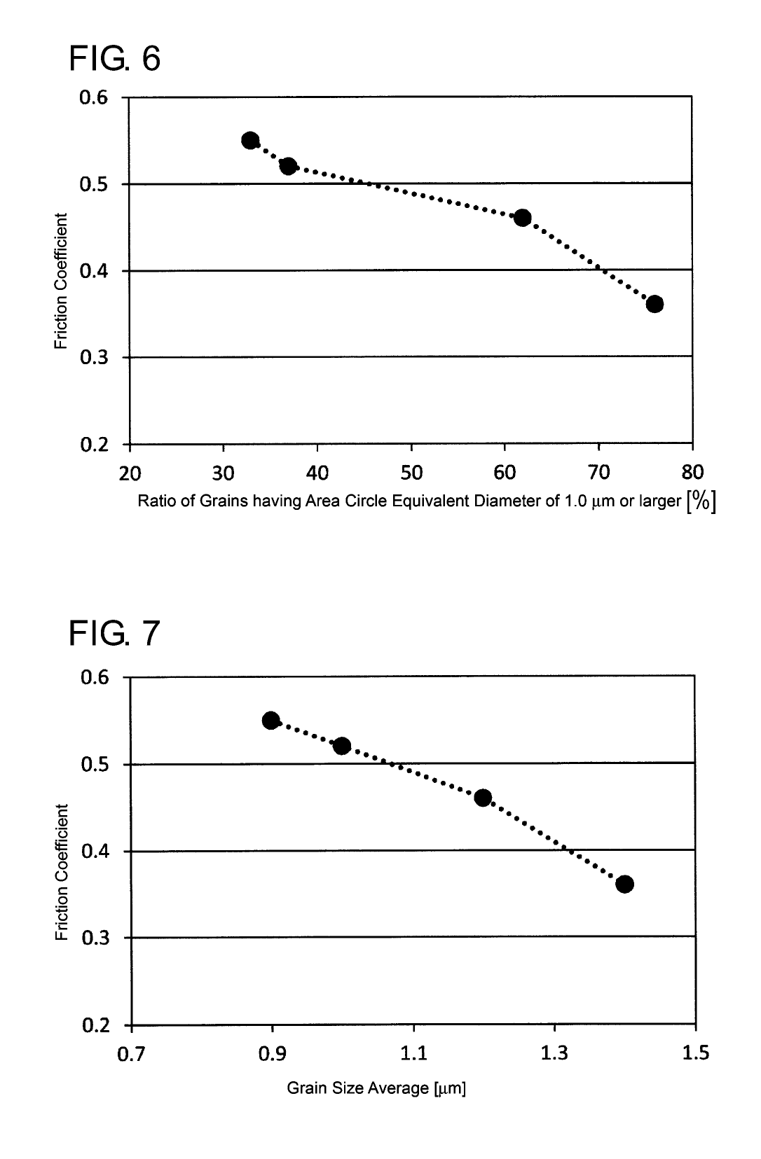

FIG. 6 shows a relationship between a ratio of the grains having the area circle equivalent diameter of 1.0 μm or larger and the dynamic friction coefficient (value at a sliding distance of 5 mm, the same applies also to FIG. 7) for each Example. On the other hand, FIG. 7 shows a relationship between a grain size average (average value of the area circle equivalent diameters) and the dynamic friction coefficient for each Example.

Further, numerical values obtained in each test were summarized and shown for Examples 1 to 4 in Table 1 below.

TABLE 1

| | EX. 1 | EX. 2 | EX. 3 | EX. 4 |
|---|---|---|---|---|
| Heating temperature | 240° C. | 260° C. | 280° C. | 300° C. |
| Ratio of grains having area circle | 33% | 37% | 62% | 76% |
| equivalent diameter of 1.0 μm | | | | |
| or larger | | | | |
| Average of area circle equivalent | 0.9 μm | 1.0 μm | 1.2 μm | 1.4 μm |
| diameters (grain size average) | | | | |
| Number of grains per 500 μ² | 309 | 230 | 164 | 120 |
| Exposed area ratio | 80% | 77% | 67% | 56% |
| Dynamic friction coefficient | 0.55 | 0.52 | 0.46 | 0.36 |

(1) State of Alloy Containing Layer

According to the SEM images of FIGS. 3, when the heating temperature was changed in Examples 1 to 4, numerous narrow and small grains were present under a condition that the heating temperature was low, whereas each grain became larger and anisotropy became smaller as the heating temperature increased. This is thought to be because the crystallinity of th.e tin-palladium alloy increased according to heating at high temperatures.

As summarized in Table 1 in response to such a change of the SEM images, the number of the grains per 500 μm² decreased in the order of Examples 1 to 4. The exposed area ratio of the tin-palladium alloy became lower.

Focusing on the area circle equivalent diameter, the area circle equivalent diameter of each grain became larger in response to a similar change of the SEM images. That is, in the grain size distribution shown in FIGS. 4 and using the area circle equivalent diameter as an index, the distribution was shifted toward a large diameter side as a whole in the order of Examples 1 to 4. distribution width also became larger,

As summarized in Table 1, the average value of the area circle equivalent diameters became larger in the order of Examples 1 to 4. The ratio of the grains having the area circle equivalent diameter of 1.0 μm or larger also becamelarger in this order.

As just described, a change of the state of the tin-palladium alloy grains recognized in the SEM images can be quantitatively evaluated by using the area circle equivalent diameter as an index of the grain size distribution. Further, the average value of the area circle equivalent diameters became about 1.5 times as much from Example 1 to Example 4, whereas the ratio of the grains having the area circle equivalent diameter of 1.0 μm or larger became 2.3 times as much. By making an evaluation based on not the average value, but the ratio of the grains having a predetermined value or larger when the area circle equivalent diameter is used as an index of evaluation, a change of the state of the tin-palladium alloy grains can be particularly sensitively recognized.

(2) Relationship of Friction Coefficient and State of Abrasion with Grain Size Distribution

According to the observation results of FIGS. 5 on the abraded states of the embossed contact points by the optical microscope, abrasion is notably seen in Comparative Example 1. In each Example, abrasion is less than in the case of Comparative Example 1. Particularly, an abraded part became smaller in the order of Example 1 to Example 4. In correspondence with this, the friction coefficient in each Example was lower than in the case of Comparative Example 1 in the measurement results of the friction coefficient shown in FIGS. 5. Further, the friction coefficient decreased in the order of Example 1 to Example 4.

Further, FIG. 6 shows the relationship between the friction coefficient and the ratio of the grains having the area circle equivalent diameter of 1.0 μm or larger. This relationship shows such a onotonous decreasing tendency that the friction coefficient is reduced as the ratio of the grains having the area circle equivalent diameter of 1.0 μm or larger becomes higher. This indicates that the friction coefficient on the surface becomes lower as the grains of the tin-palladium alloy grow larger. The friction coefficient had a low value of 0.6 or lower when the ratio of the grains having the area circle equivalent diameter of 1.0 μm or larger was 30% or higher, and the friction coefficient further decreased to 0.5 or lower when the ratio of the grains having the area circle equivalent diameter of 1.0 μm or larger was 60% or higher. Further, in a region where the ratio of the grains having the area circle equivalent diameter of 1.0 μm or larger is 60% or higher, a decreasing gradient of the friction coefficient suddenly became larger as compared to a region where the ratio of the grains having the area circle equivalent diameter of 1.0 μm or larger was below 60%.

Furthermore, in the relationship of FIG. 7 between the friction coefficient and the average value of the area circle equivalent diameters, the friction coefficient also shows a monotonous decreasing tendency. However, a behavior in which a reduction of the friction coefficient associated with grain growth suddenly occurred substantially in a region where the friction coefficient was 0.5 or lower in dependency of FIG. 6 on the ratio of the grains having the area circle equivalent diameter of 1.0 μm or larger, whereas the friction coefficient only moderately changed in the entire region in dependency of FIG. 7 on the grain size average. This indicates that a change of the friction coefficient can be more sensitively evaluated based on the ratio of the grains having the area circle equivalent diameter of 1.0 μm or larger han based on the average value in evaluating the friction coefficient using the area circle equivalent diameter as an index.

Although the embodiment of the present disclosure has been described in detail above, the present disclosure is not limited to the above embodiment at all and various changes can be made without departing from the gist of the present disclosure.

1. A connection terminal comprising:
an alloy containing layer, in which grains of an alloy part made of an alloy mainly containing tin and palladium are present in a tin part made of pure tin or an alloy having a higher tin ratio than the alloy part, wherein:
both the alloy part and the tin part are exposed on an outermost surface, on a surface of a contact point to be electrically brought into contact with another conductive member,
a number of the grains having an area circle equivalent diameter of 1.0 μm or larger is 30% or higher to a total number of the grains in a grain size distribution of the grains of the alloy part on the outermost surface of the contact point.

2. The connection terminal according to claim 1, wherein the number of the grains having the area circle equivalent diameter of 1.0 μm or larger is 60% or higher to the total number of the grains in the grain size distribution of the grains of the alloy part on the outermost surface of the contact point.

3. The connection terminal according to claim 1, wherein an underlayer made of nickel or nickel alloy is provided between a base material forming the connection terminal and the alloy containing layer.

4. The connection terminal according to claim 1, wherein an exposed area ratio of the alloy part occupying a surface of the alloy containing layer is 10% or higher and 95% or lower.

5. The connection terminal according to claim 1, wherein a number of the grains of the alloy part exposed on the outermost surface per area of 500 μm² of the outermost surface of the contact point is 10 or more and 400 or less.

6. A connection terminal pair, comprising:
the connection terminal according to claim 1; and
a mating terminal to be electrically brought into contact with the connection terminal on the contact point.

7. The connection terminal pair according to claim 6, wherein the mating terminal is such that a metal layer having a lower hardness than the alloy part is exposed on a surface of the contact point to be electrically brought into contact with the connection terminal.
